(19) United States
(12) Patent Application Publication
(10) Pub. No.: US 2024/0039224 A1
(43) Pub. Date: Feb. 1, 2024

(54) SINGLE-PAIR ETHERNET PLUGGABLE MODULE

(71) Applicant: METHODE ELECTRONICS, INC., Chicago, IL (US)

(72) Inventors: Luis Torres, Palatine, IL (US); James M. Cunneen, Chicago, IL (US); Alexandros Pirillis, Chicago, IL (US); Luis Gasca, Chicago, IL (US)

(21) Appl. No.: 18/225,042

(22) Filed: Jul. 21, 2023

Related U.S. Application Data
(60) Provisional application No. 63/393,669, filed on Jul. 29, 2022.

(51) Int. Cl. H01R 31/06; H01R 12/72; H04L 69/08

(52) U.S. Cl. CPC H01R 31/065; H01R 12/721; H04L 69/08

(57) ABSTRACT

The present invention provides for a first PHY including an SGMII Ethernet host interface and a second PHY including a Single Pair Ethernet (SPE) protocol and the module provides for migration of standard SGMII host interface Ethernet to SPE protocol wherein communication over single twisted pair on a line side interface of the module is provided

### CROSS-REFERENCE TO RELATED APPLICATIONS

This application claims the benefit of U.S. Provisional App. No. 63/393,669 filed Jul. 29, 2022; the aforementioned application being hereby incorporated by reference in its entirety.

### BACKGROUND

The present invention pertains to a pluggable module with a line-side interface that is compliant with Single Pair Ethernet protocols , including but not limited to, 10BASE-T1L, and the Small Form Factor Pluggable (SFP) multi-source agreement (MSA) for the host side interface. This pluggable module is capable of Ethernet transmissions via single twisted pair copper media at rates ranging from 10 Mbps to 1 Gbps.

Presently, so called Operational Technology (OT) networks found in industrial control and building automation settings are built and connected using technologies and protocols developed for that particular purpose. OT networks might be connected using one or more of such technologies and protocols that include, amongst many other, PROFINET, Modbus, CANopen, Fieldbus and PROFIBUS. This plethora of OT network connectivity technologies and solutions are historically not associated with or even connected to Ethernet-based Information Technology (IT) networks. Moreover these legacy OT technologies and protocols are becoming increasingly more challenging to support and maintain as they age. The additional challenge of enhancing cyber-security has contributed to the need to improve and harmonize the means by which today's OT networks are connected—not just within the OT network but to existing IT infrastructure.

The Single Pair Ethernet pluggable module described here facilitates the means by which OT equipment can be connected to Ethernet-based IT equipment and networks, thus eliminating the need for old, built-for-purpose OT technologies and protocols so that all the advantages of Ethernet technology can be fully realized and leveraged. The present invention serves as a bridge between the OT system cable infrastructure and Ethernet IT equipment and systems.

### SUMMARY

The present invention provides a pluggable module comprising a housing having a first end and a second end, a printed circuit board (PCB) mounted within the housing and the PCB has an extended PCB portion at the first end a connector at the PCB extended portion at the first end of the PCB and a second end of the PCB at the second end of the housing to form an edge connector as the host interface, wherein the connector at the first end provides a Single Pair Ethernet (SPE) interface.

In an embodiment, the connector is mounted at the PCB extended portion at the first end of the PCB. The connector provides SPE interface and may include one of a three wire terminal block, a horizontal style connector block, a vertical style connector block an LC style copper jack and a wire trap style connector block.

In an embodiment a first PHY may provide an SGMII Ethernet host interface and a second PHY may provide an SPE interface. In an embodiment the first PHY is provided on the PCB proximate the first end of the PCB. In an embodiment the second PHY may be provided on the PCB proximate the second end of the PCB. In an embodiment first and second PHY devices provide for migration of standard SGMII host interface Ethernet to SPE protocol. In an embodiment the module provides for communication over single twisted pair on a line side interface of the module. In an embodiment a portion of the PCB provides an enlarged housing portion to extend beyond a bezel of a host device.

In an embodiment the invention provides a housing having a first end and a second end, the housing having a first PHY including an SGMII Ethernet host interface and a second PHY including a Single Pair Ethernet (SPE) protocol; the first and second PHY devices provide for migration of standard SGMII host interface Ethernet to SPE protocol wherein communication over single twisted pair on a line side interface of the module is provided. See Analog Devices, “ADIN1100 SPE PHY Datasheet” pp. 1-80 (2021-2023) and Microsemi Corporation, MAX24287 1 Gbps Parallel-Serial MII Converter“, pp. 1-72, Data Sheet, November 2016 datasheet.

In an embodiment the pluggable module further comprises a FPGA I2C to MDIO, a serial ID chip, power supply chip, and a terminal connector block including a copper connector. In an embodiment the first PHY is located proximate the second end of the housing and a second PHY is located proximate the first end of the housing. In an embodiment the line side interface comprises one of a three wire terminal block; a horizontal style connector block; a vertical style connector block; an LC style copper jack and a wire trap style connector block.

In an embodiment a line side interface connector is mounted on an extended portion of a printed circuit board (PCB) and the extended PCB portion forming an enlarged housing portion of the module extending beyond a bezel of a host device. In an embodiment the host device is migrated to SPE protocol upon mating of the module thereto. In an embodiment the first PHY is mounted at a first end of a printed circuit board (PCB) and the second PHY is mounted at a second end of a printed circuit board (PCB). In an embodiment the first end of the PCB is located proximate a first end of the housing and the second end of the PCB is located proximate a second end of the housing.

In an embodiment a module is provided comprising a first PHY including an SGMII Ethernet host interface and a second PHY including a Single Pair Ethernet (SPE) protocol; the module provides for migration of standard SGMII host interface Ethernet to SPE protocol wherein communication over single twisted pair on a line side interface of the module is provided.

### BRIEF DESCRIPTION OF THE DRAWINGS

While particular embodiments of the present invention are depicted in the drawing figures, as described below, the invention is broader than these specific embodiments and is bound only by the claims as granted by the patent office.

FIG. 1 is a plan view of a Printed Circuit Board (PCB) of the present invention;

Fig. 1a is a block diagram view of the functioning of the module and PCB of FIG. 1;

FIG. 2 is a perspective view of five embodiments of the present invention shown with connector blocks mounted on PCBs;

FIG. 3 is a perspective view of five embodiments of the present invention as shown in FIG. 2 and depicting cut-away views of connector blocks;

FIG. 4 depicts seven plan views of one embodiment of the present invention, including a module housing;

FIG. 5 is a perspective view of the module of FIG. 4;

FIG. 5a is a perspective view of the module of FIG. 5 being mated to a cage of a host device;

FIG. 5b depicts two side elevation views of the module of the present invention being mated to a cage of a host device;

FIG. 5c is a side elevation view of FIG. 5b, depicting a connector block and PCB in dashed lines;

FIG. 6 depicts two views of an alternative embodiment of a connector block of the present invention;

FIG. 6a depicts the connector block of FIG. 6 within a module housing and mounted to a PCB (shown in dashed lines);

FIG. 7 depicts two views of an alternative embodiment of a connector block of the present invention;

FIG. 7a depicts the connector block of FIG. 7 within a module housing and mounted to a PCB (shown in dashed lines);

FIG. 8 depicts two views of an alternative embodiment of a connector block of the present invention; and

FIG. 8a depicts the connector block of FIG. 8 within a module housing and mounted to a PCB (shown in dashed lines).

### DETAILED DESCRIPTION

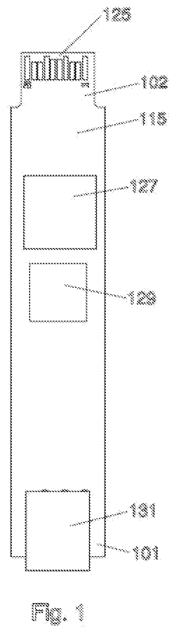

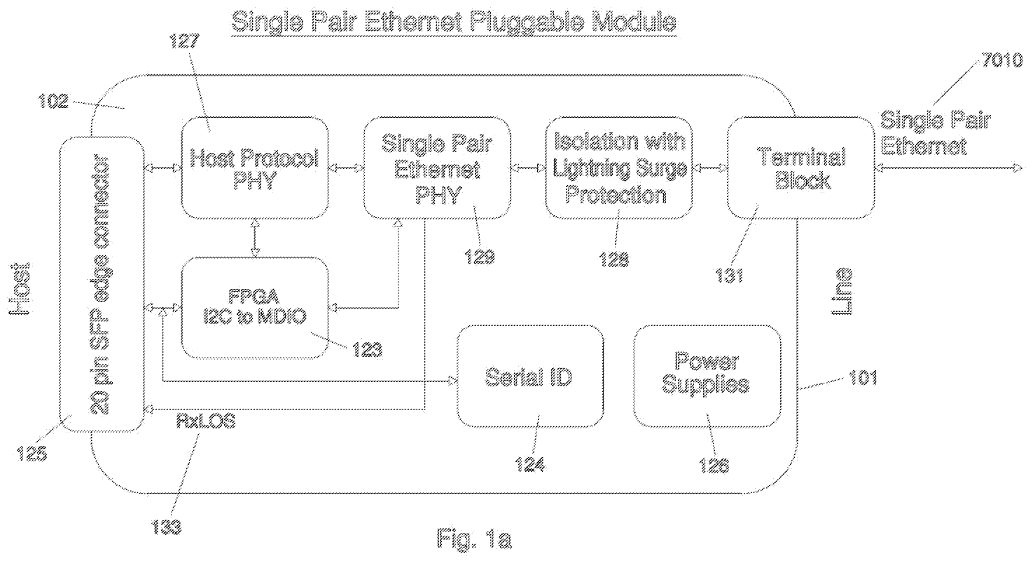

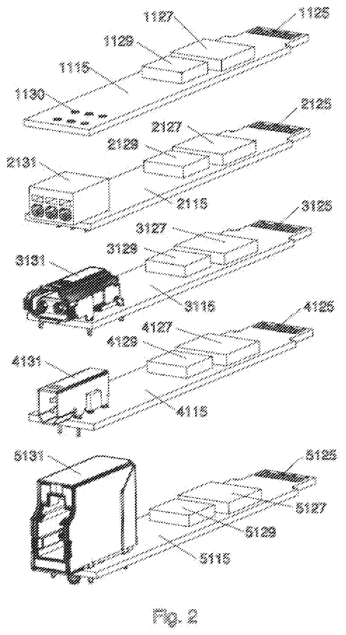

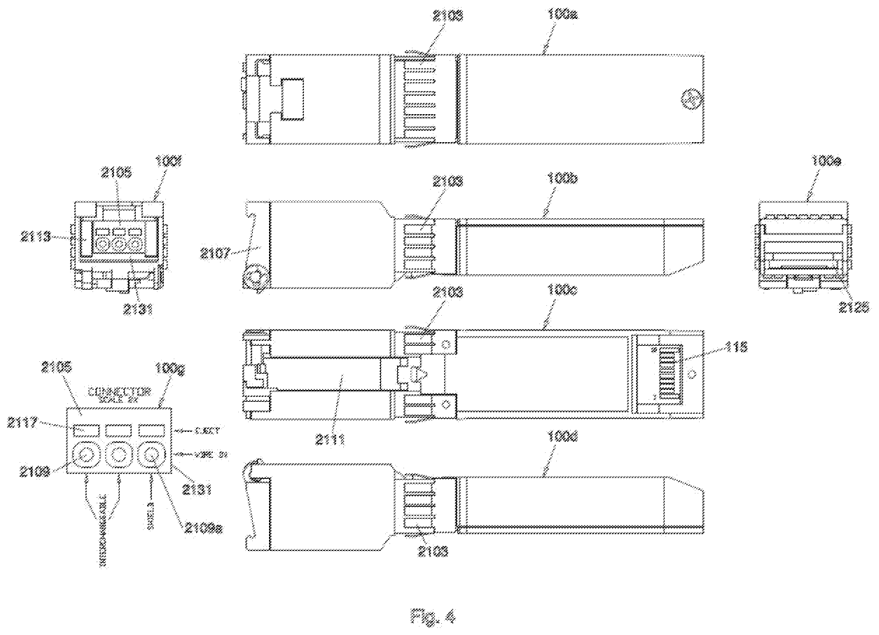

Embodiments of the invention are depicted in FIGS. 1-8. The present invention includes a module housing 100 as shown in FIGS. 4-8. The housing contains a printed circuit board (PCB) that contains connectors at a first end 101 and second end 102 (FIG. 1). The operation of the module may be understood with respect to PCB depicted in FIG. 1 and block diagram of Fig. la. The PCB 115 includes components, such as a FPGA configured as an I2C-to-MDIO bridge, a serial ID EEPROM chip 124, power supply chip 126, host interface PHY chip 127, a chip for Single Pair Ethernet protocol PHY 129 and a terminal (connector) block 131 such as a copper connector 2131, 3131, 4131, 5131 (as shown in FIG. 2). In an alternative embodiment other copper connectors may be provided. Other components (not shown) include resistors, capacitors etc. mounted on the top or bottom of PCB 115. In an embodiment, the PCB 115 may have hard gold plating to form 10 contacts (per side) 125 to form an edge connector at the second end 102 that is compliant with SFP MSA. The edge connector 125 connects the pluggable module to a host device such as an Ethernet switch. In a preferred embodiment the pluggable module includes lightning surge protection components 128 capable of providing protection to at least the ITU-T K.21 basic protocol limits. The inclusion of lightning surge protection allows for Single Pair Ethernet links to run outside building infrastructure, not just within, as might be necessary for connecting to rooftop installed remote equipment or connecting equipment between buildings. Element 128 depicts both isolation and lightning surge protection. Isolation relates to Galvanic electrical isolation, and the signal is transformer coupled. Lightning surge protection is implemented using, but not limited to, a pair of gas discharge tubes (GDTs). Logically isolation and lightning surge protection may be associated together and may be located closely behind the single pair Ethernet physical connector; the terminal block connector (element 131) in the block diagram. In another embodiment, a non-native lightning surge protection may be provided separately from the PCB 115.

Mounted at the first end 101 is terminal block 131 that connects the pluggable module to a plug/cable (not shown) receiving signals of Single Pair Ethernet protocol and able to accommodate a cable ranging in diameter between 24-16 AWG (7010) as shown in FIG. 1a. In an embodiment, the terminal block connector 131 contains two pins for transmission of Single Pair Ethernet protocol signals (alternatively with a ground pin 2109a (FIG. 4)). Once the pluggable module is mated to a host device the 20 pin SFP edge connector with 125 grounding to the host device, transmissions may begin.

In an embodiment the module may provide the following functionality:
Supports 10BASE-T1L Links up to 1000 m using Single Pair Cable
SFF-8431 and SFF-8432 MSA Compliant
IEEE802.3cg Compliant
Low Power Consumption—less than 1 W
Low Radiated Emissions
I2C 2-Wire Host Serial Interface
Two Discreet Implementations for Register Access
   MDIO to I2C Bridge for Register Access to Configure and Control
   Debug Register Mode Interface also for Configuration and Control
Robust Die Cast Housing
Bail Latch Style ejector mechanism
Unshielded and Shielded Single Pair Ethernet cable support
Lightning Surge Protection Compliant to ITU-T K.21
Able to Co-Exist with PoDL/SPoE Line-Side Voltage

The pluggable module provides an industry standard host interface to network platforms that have an MSA compliant SFP port 125. The pluggable module has two interfaces: the host side which may be implemented, but isn't limited to, SGMII, 1000BASE-x or equivalent interface 102 and the line side Single Pair Ethernet Protocol interface 101 that may, but is not limited to, include 10BASE-T1L. In addition, the pluggable module provides an I2C to MDIO bridge 123 to allow user access to the registers within the host protocol PHY and the Single Pair Ethernet PHY 129 (shown in the Fig. la) for the purpose of control and configuration. Loss of link from the line side is indicated to the Host as an output from the pluggable module via the RxLOS pin 133. The pluggable module also includes a register set within an EEPROM for the purpose of implementing Serial ID consistent with the SFP MSA. The total power consumption of the Single Pair Ethernet Pluggable module is within SFP MSA specification. In a preferred embodiment the total power consumption of the pluggable Single Pair Ethernet modules is below 1W maximum.

The contact pads on the PCB 125 may be designed for a sequenced mating as follows:
First mate: Ground contacts
Second mate: Power contacts
Third mate: Signal contacts

Turning to FIG. 2, five embodiments are depicted. The first embodiment shows the PCB 1115 having contact fingers forming the edge connector 1125. Mounted on the top side of the PCB is the host protocol physical layer device (PHY) chip 1127 and Single Pair Ethernet PHY chip 1129. At the end opposite the edge connector 1125 are PCB thru-holes 1130 for receiving contact tails of a connector to be mounted therein.

The second embodiment shows the PCB 2115 having contact fingers forming the edge connector 2125. Mounted on the top side of the PCB is the host protocol PHY 2127 and the Single Pair Ethernet PHY 2129. At the end opposite the edge connector 2125 is three wire terminal block 2131 type connector for Single Pair Ethernet.

The third embodiment shows the PCB 3115 having contact fingers forming the edge connector 3125. Mounted on the top side of the PCB is the host protocol PHY 3127 and the Single Pair Ethernet PHY 3129. At the end opposite the edge connector 3125 is a horizontal style single pair ethernet (SPE) connector block 3131 type for Single Pair Ethernet protocol.

The fourth embodiment shows the PCB 4115 having contact fingers forming the edge connector 4125. Mounted on the top side of the PCB is the host protocol PHY 4127 and the Single Pair Ethernet PHY 4129. At the end opposite the edge connector 4125 is a vertical SPE style connector block 4131 type for Single Pair Ethernet Protocol.

The fifth embodiment shows the PCB 5115 having contact fingers forming the edge connector 5125. Mounted on the top side of the PCB is the host protocol PHY 5127 and the Single Pair Ethernet PHY 5129. At the end opposite the edge connector block 5125 is a LC style copper jack/connector 5131.

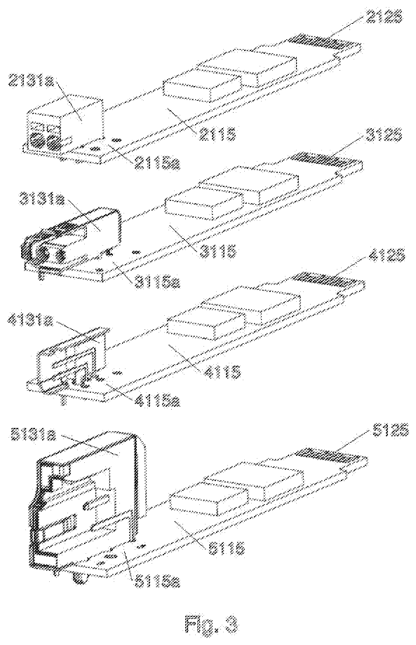

Turning to FIG. 3, the five embodiments are shown with side elevation cut-away views of each connector block 2131a, 3131a, 4131a and 5131a mounted to the corresponding extended PCB portion 2115a, 3115a, 4115a and 5115a, respectively of each PCB. Each PCB includes an edge connector compliant with SFP MSA 2125, 3125, 4125 and 5125, respectively.

With respect to FIG. 4, seven views of the module are depicted. The top view of module 100a depicts the module having a three-wire trap connector block 2131 enclosed by a housing 100 that, in an embodiment may be zinc die cast with nickel plating. The housing includes grounding tabs 2103 surrounding the module. Left side view of module 100b also shows grounding tabs 2103. In an embodiment the grounding tabs may be copper alloy with nickel plating. A bottom view of module 100c depicts ejector actuator 2111 that interacts with bail latch 2107 to release the module from a host device.

A right side view of module 100d also depicts grounding tabs 2103 protruding from the surface of the housing 100d. End view 100e depicts the edge connector 2125 disposed in the opening at the second end of the module. End view 100f depicts three wire trap connector block 2131 formed with insulating plastic block material (PA 94V-D rated) 2105, including light pipe 2113 (clear Lexan 94V-D rated). Finally, an enlarged view of connector block 100g is depicted with wire receptacle 2109 (transmit and receive) and shielding/ground receptacle 2109a. Three ejection apertures 2117 are located above each receptacle 2109. In an embodiment, each ejection aperture 2117 may receive a tool (e.g. screwdriver) to release the wire from contact within the connector block 2131.

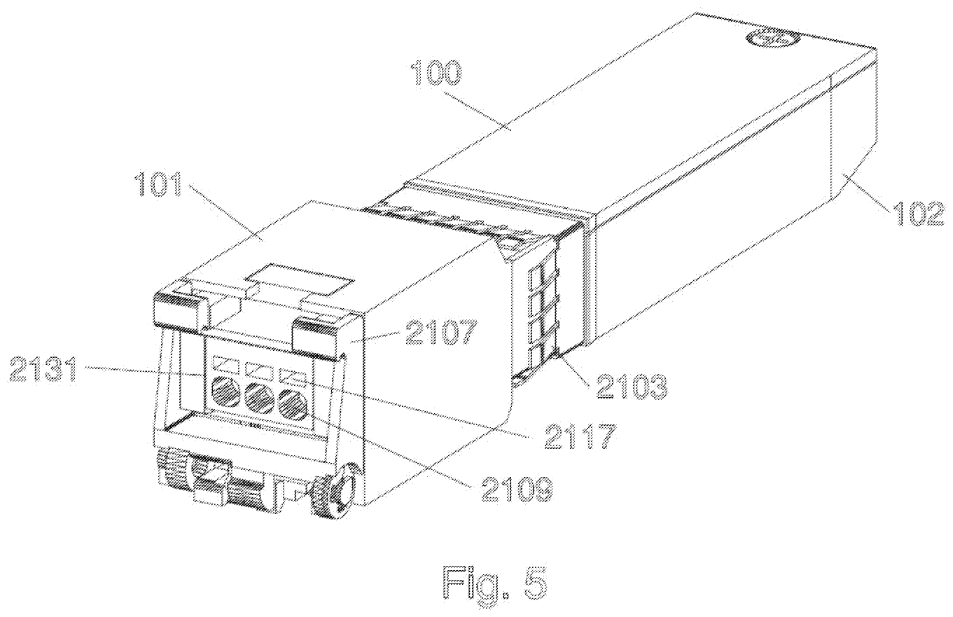

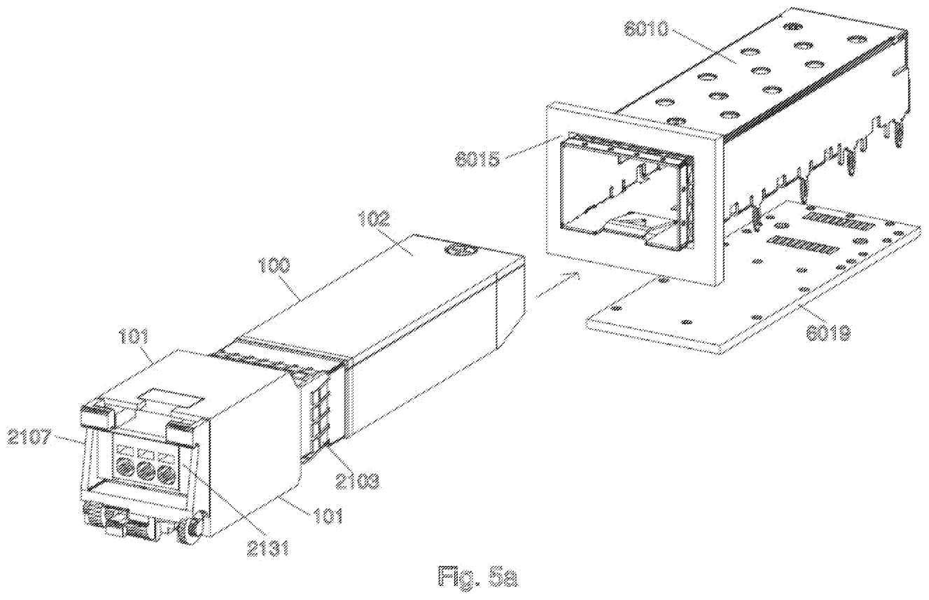

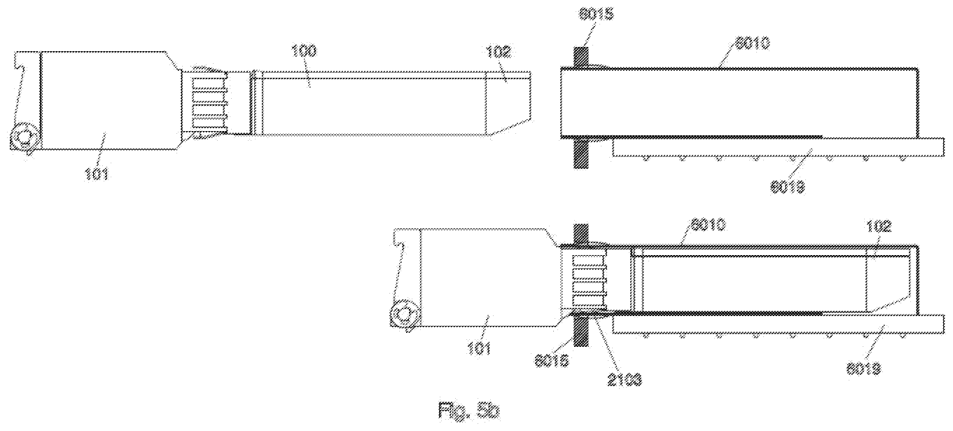

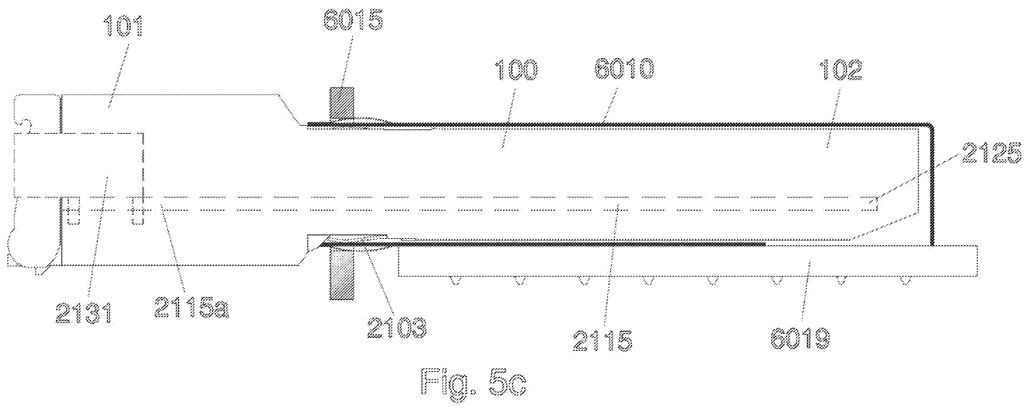

FIG. 5 is a perspective view of the module 100 having a first end 101 and second end 102. Grounding tab 2103 surrounds the housing 100 adjacent the first end 101. At the first end 101 is three wire trap block 2131 having wire receptacles 2109 and ejection apertures 2117. In an embodiment, the wire has 26-20 gauge with 6 mm strip length. Surrounding the block 2131 on three sides is bail latch mechanism 2107. In an embodiment, the bail latch 2107 is formed of steel with gold flash and nickel plating.

FIG. 5a depicts the module 100 being mated to a cage 6010 of a host device such as a router, server, etc. The cage includes a bezel 6015 and is mounted to mother board 6019. Upon insertion of the module 100 within cage 6010, the second end 102 is inserted along cage 6010 until the grounding tabs 2103 engage the cut-out of the bezel 6015 and the enlarged housing portion of the first end 101 of the module 100 abuts the rectangular cage opening 6010 and/or the bezel face 6015. Once mounted within cage 6010, a cable having stripped wires (not shown) may be inserted into the three wire trap connector block 2131, so that signals may pass between a host motherboard 6019, the PCB 2115 and, in an embodiment, the 10BASE-T1L device terminated at the module 100. To remove the module 100 from the cage 6010, an operator grabs the bail latch 2107 and pulls away from the cage 6010, rotating the bail latch 2107 and ejecting the module 100 from the cage 6010.

The SFP transceiver latch 2107 should be mechanically robust and designed to prevent unintentional unlatching during insertion or extraction of the transceiver cable (not shown). The transceiver is designed with a bail type ejector latch mechanism 2107 (FIG. 5) that allows the module to be easily released from a cage 6010, when the adjacent SFP ports in both rows of the host device are also populated (not shown) and regardless of whether the SFP module is placed in the lower row or upper row. The latch 2107 shall also pass the “wiggle” RJ45 connector stress test.

FIG. 5b depicts a side view of the module 100 prior to and after mating to cage 6010. Bezel 6015 is depicted surrounding the cage 6010 and upon insertion of the module within the cage 6010 with the grounding tabs 2103 make grounding contact with the bezel 6015 to reduce EMI. In the mated orientation, only the first end of the housing 101 extends beyond the host device cage 6010. FIG. 5c depicts a side view of the module 100 mated within cage 6010 and showing connector block 2131 at first end 101 mounted to PCB 2115 (each shown in dashed lines). By providing an extended PCB portion 2115a beyond the grounding tab portion 2103, the connector block 2131 may be easily mounted and accessed within the first end 101 of module 100 (opposite edge connector 2125).

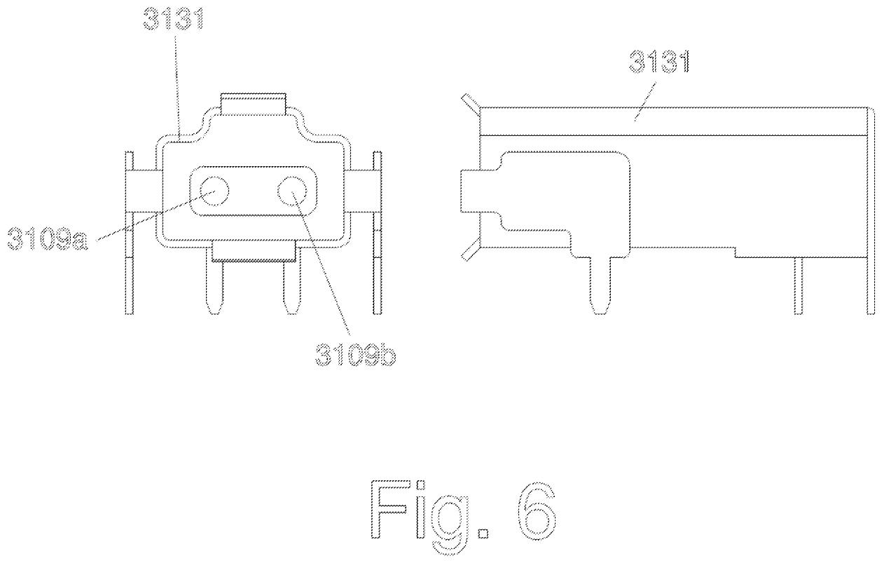

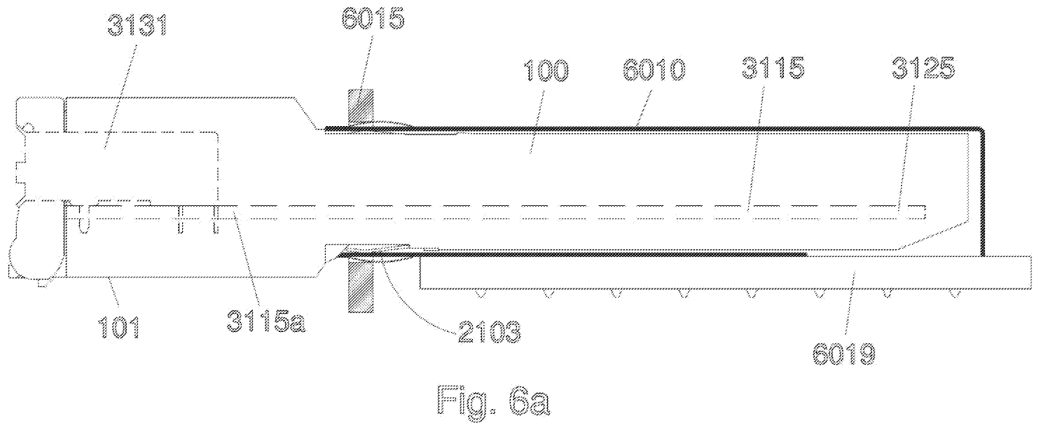

Turning to FIG. 6, the horizontal (rounded) connector block 3131 is depicted showing first and second receptacles 3109a, 3109b. FIG. 6a depicts module 100 mated within cage 6010, showing the extended PCB portion 3115a with connector 3131 mounted within the module housing 100, so that the connector block 3131 is mounted at the first end 101 (opposite edge connector 3125).

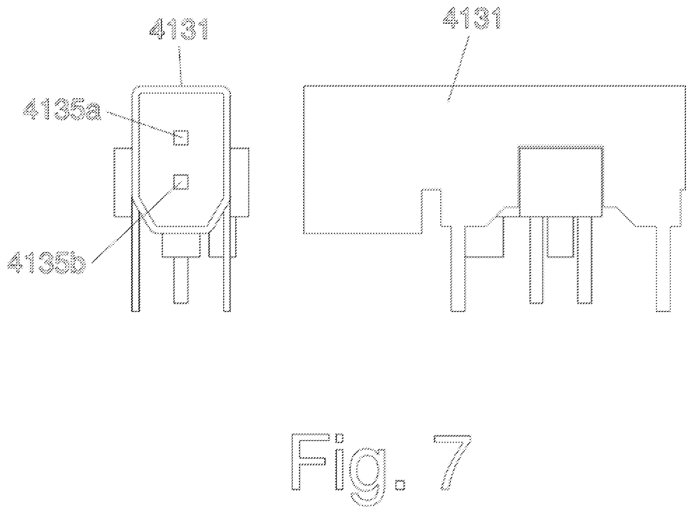

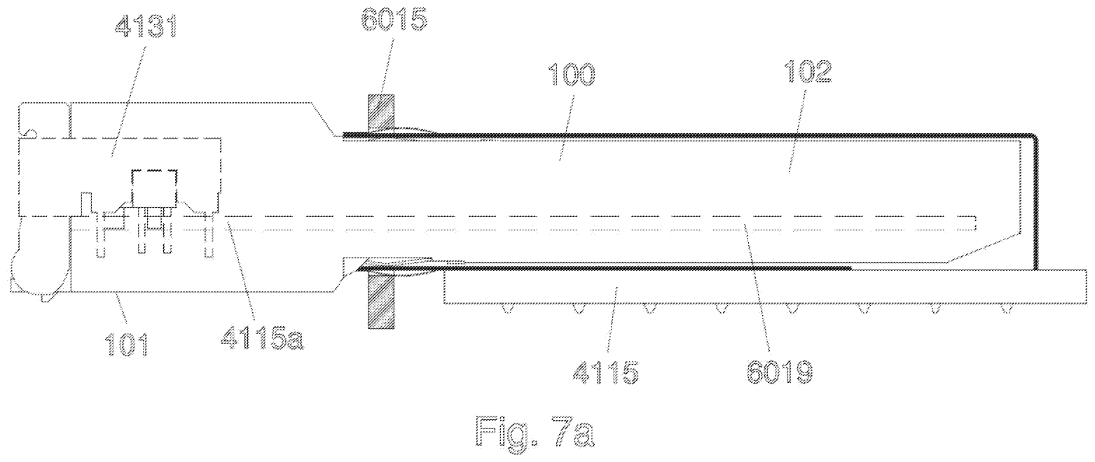

Turning to FIG. 7, the vertical rectangular connector block 4131 is depicted showing first and second pins 4135a, 4135b. FIG. 7a depicts module 100 mated within cage 6010, showing the extended PCB portion 4115a with connector block 4131 mounted within the module housing 100, so that the connector block 4131 is mounted at the first end 101 (opposite edge connector 4125).

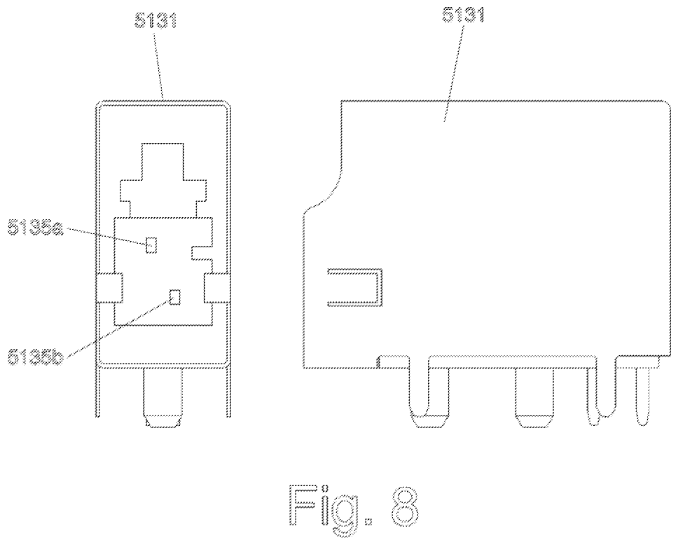

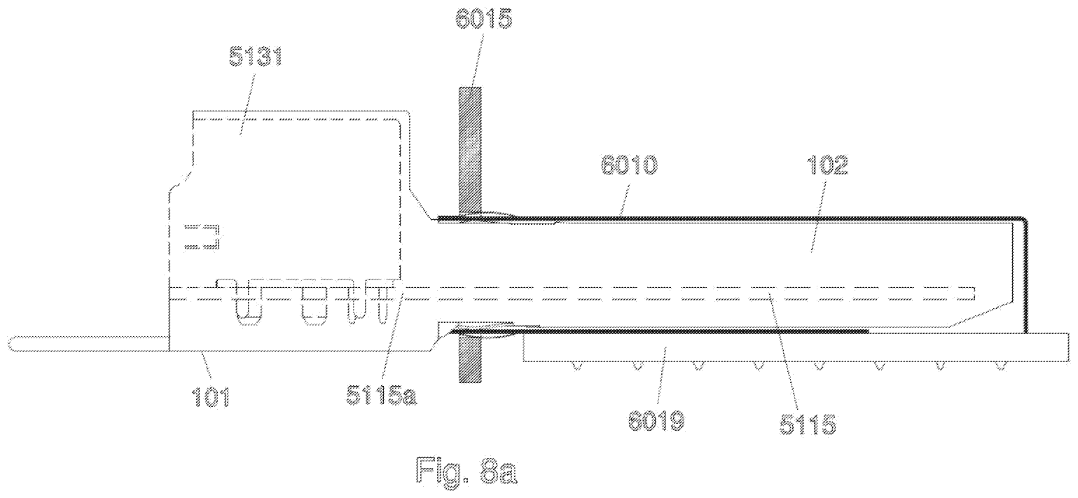

Turning to FIG. 8, the LC type copper connector block 5131 is depicted showing first and second pins 5135a, 5135b. FIG. 8a depicts module 100 mated within cage 6010, showing the extended PCB portion 5115a with connector block 5131 mounted within the module housing 100, so that the connector block 5131 is mounted at the first end 101 (opposite edge connector 5125).

While the above specification describes embodiments of the present invention, the bounds of the invention are to be interpreted according to the claims of the patent according to one having ordinary skill in the art.

What is claimed is:

1. A pluggable module comprising:
a housing having a first end and a second end;
a printed circuit board (PCB) mounted within the housing and the PCB has an extended PCB portion at the first end;
a connector at the PCB extended portion at the first end of the PCB and a second end of the PCB at the second end of the housing to form an edge connector as a host interface;
wherein the connector at the first end provides a Single Pair Ethernet (SPE) interface.

2. The pluggable module of claim 1, wherein the Single Pair Ethernet (SPE) interface connector is mounted at the PCB extended portion at the first end of the PCB.

3. The pluggable module of claim 1, wherein the connector provides a SPE interface and includes one of a three wire terminal block; a horizontal style SPE interface connector; a vertical style SPE connector; an LC style copper jack and a wire trap style connector block.

4. The pluggable module of claim 1, further comprising a first Physical Layer Device or PHY providing SPE interface to a line side single pair media and a second PHY providing an SGMII Ethernet interface to the host.

5. The pluggable module of claim 1 wherein a first PHY is provided on the PCB proximate the first end of the PCB.

6. The pluggable module of claim 1 wherein a second PHY is provided on the PCB proximate the second end of the PCB.

7. The pluggable module of claim 1 wherein first and second PHY devices collectively provide for migration of standard SGMII host interface Ethernet to SPE protocol on a line side.

8. The pluggable module of claim 1 wherein the module provides for communication over single twisted pair on a line side interface of the module.

9. The pluggable module of claim 1 wherein the extended portion of the PCB provides an enlarged housing portion to extend beyond a bezel of a host device.

10. A pluggable module comprising:
a housing having a first end and a second end;
the housing having a first physical layer (PHY) device including a Single Pair Ethernet (SPE) protocol and a second PHY device including an SGMII Ethernet host interface;
the first and second PHY devices provide for migration of standard SGMII host interface Ethernet to SPE protocol wherein communication is achieved over single twisted pair on a line side interface connector of the module.

11. The pluggable module of claim 10 further comprising a FPGA configured as an I2C-to-MDIO bridge; a serial ID EEPROM chip; power supply chip; and a terminal connector block including a copper connector.

12. The pluggable module of claim 10 wherein the first PHY is located proximate the first end of the housing.

13. The pluggable module of claim 10 wherein the second PHY is located proximate the second end of the housing.

14. The pluggable module of claim 10 wherein the line side interface connector comprises one of a three wire terminal block; a horizontal style SPE connector block; a vertical style SPE connector block; an LC style copper jack and a wire trap style connector block.

15. The pluggable module of claim 14 wherein the line side interface connector is mounted on an extended portion of a printed circuit board (PCB) and the extended PCB portion forming an enlarged housing portion of the module extending beyond a host equipment bezel surface.

16. The pluggable module of claim 15 wherein a host device is migrated to SPE protocol upon mating of the module thereto.

17. The pluggable module of claim 10 wherein the first PHY is mounted at a first end of a printed circuit board (PCB).

18. The pluggable module of claim 10 wherein the second PHY is mounted at a second end of a printed circuit board (PCB).

19. The pluggable module of claim 18 wherein the first end of the PCB is located proximate a first end of the housing and the second end of the PCB is located proximate a second end of the housing.

20. A module comprising:
a first physical layer (PHY) device including a Single Pair Ethernet (SPE) protocol and a second PHY device including an SGMII Ethernet host interface;
the module provides for migration of standard SGMII host interface Ethernet to SPE protocol wherein communication over single twisted pair on a line side interface of the module is provided.

What is claimed is:

1. A pluggable module comprising:
a housing having a first end and a second end;
a printed circuit board (PCB) mounted within the housing and the PCB has an extended PCB portion at the first end;
a connector at the PCB extended portion at the first end of the PCB and a second end of the PCB at the second end of the housing to form an edge connector as a host interface;
wherein the connector at the first end provides a Single Pair Ethernet (SPE) interface.

2. The pluggable module of claim 1, wherein the Single Pair Ethernet (SPE) interface connector is mounted at the PCB extended portion at the first end of the PCB.

3. The pluggable module of claim 1, wherein the connector provides a SPE interface and includes one of a three wire terminal block; a horizontal style SPE interface connector; a vertical style SPE connector; an LC style copper jack and a wire trap style connector block.

4. The pluggable module of claim 1, further comprising a first Physical Layer Device or PHY providing SPE interface to a line side single pair media and a second PHY providing an SGMII Ethernet interface to the host.

5. The pluggable module of claim 1 wherein a first PHY is provided on the PCB proximate the first end of the PCB.

6. The pluggable module of claim 1 wherein a second PHY is provided on the PCB proximate the second end of the PCB.

7. The pluggable module of claim 1 wherein first and second PHY devices collectively provide for migration of standard SGMII host interface Ethernet to SPE protocol on a line side.

8. The pluggable module of claim 1 wherein the module provides for communication over single twisted pair on a line side interface of the module.

9. The pluggable module of claim 1 wherein the extended portion of the PCB provides an enlarged housing portion to extend beyond a bezel of a host device.

10. A pluggable module comprising:
a housing having a first end and a second end;
the housing having a first physical layer (PHY) device including a Single Pair Ethernet (SPE) protocol and a second PHY device including an SGMII Ethernet host interface;
the first and second PHY devices provide for migration of standard SGMII host interface Ethernet to SPE protocol wherein communication is achieved over single twisted pair on a line side interface connector of the module.

11. The pluggable module of claim 10 further comprising a FPGA configured as an I2C-to-MDIO bridge; a serial ID EEPROM chip; power supply chip; and a terminal connector block including a copper connector.

12. The pluggable module of claim 10 wherein the first PHY is located proximate the first end of the housing.

13. The pluggable module of claim 10 wherein the second PHY is located proximate the second end of the housing.

14. The pluggable module of claim 10 wherein the line side interface connector comprises one of a three wire terminal block; a horizontal style SPE connector block; a vertical style SPE connector block; an LC style copper jack and a wire trap style connector block.

15. The pluggable module of claim 14 wherein the line side interface connector is mounted on an extended portion of a printed circuit board (PCB) and the extended PCB portion forming an enlarged housing portion of the module extending beyond a host equipment bezel surface.

16. The pluggable module of claim 15 wherein a host device is migrated to SPE protocol upon mating of the module thereto.

17. The pluggable module of claim 10 wherein the first PHY is mounted at a first end of a printed circuit board (PCB).

18. The pluggable module of claim 10 wherein the second PHY is mounted at a second end of a printed circuit board (PCB).

19. The pluggable module of claim 18 wherein the first end of the PCB is
located proximate a first end of the housing and the second end of the PCB is located proximate a second end of the housing.

20. A module comprising:
a first physical layer (PHY) device including a Single Pair Ethernet (SPE) protocol and a second PHY device including an SGMII Ethernet host interface;
the module provides for migration of standard SGMII host interface Ethernet to SPE protocol wherein communication over single twisted pair on a line side interface of the module is provided.
